(19) United States
(12) Patent Application Publication
(10) Pub. No.: US 2015/0188364 A1
(43) Pub. Date: Jul. 2, 2015

(54) WIRELESS POWER RECEIVING APPARATUS AND WIRELESS POWER TRANSMITTING APPARATUS

(71) Applicant: FUJITSU COMPONENT LIMITED, Tokyo (JP)

(72) Inventors: Shigemi Kurashima, Tokyo (JP); Shinichiro Akieda, Tokyo (JP); Nobuyoshi Shimizu, Tokyo (JP)

(21) Appl. No.: 14/582,301

(22) Filed: Dec. 24, 2014

(30) Foreign Application Priority Data
Dec. 27, 2013 (JP) 2013-272954

(51) Int. Cl. H02J 17/00

(52) U.S. Cl. CPC H02J 17/00

(57) ABSTRACT

A wireless power receiving apparatus for wirelessly receiving power from a power transmitting apparatus includes a first power receiving coil, and a second power receiving coil having windings thereof parallel to, and in close proximity to, windings of the first power receiving coil.

### BACKGROUND OF THE INVENTION

1. Field of the Invention

The disclosures herein relate to a wireless power receiving apparatus and a wireless power transmitting apparatus.

2. Description of the Related Art

A wireless power transmitting apparatus having a loop antenna and a self-resonant coil is known in the art (see Patent Document 1, for example). A wireless power transmission system in which an excite coil of an excite circuit is magnetically coupled to a power feeding coil is also known in the art (see Patent Document 2, for example). A power transmitting apparatus and a power receiving apparatus that constitute a noncontact power transmission system having resonant circuits including a coil and a capacitor are also known in the art (see Patent Documents 3 to 5, for example). A resonant inverter including a series resonant circuit and a parallel resonant circuit is also known in the art (see Patent Document 6, for example).

Wireless power transmission systems in the related art tend to have low efficiency in the transmission of power from a power transmitting apparatus to a power receiving apparatus.

Accordingly, there may be a need for a wireless power transmission system in which the efficiency of power transmission from a power transmitting apparatus to a power receiving apparatus is improved.
[Patent Document 1] Japanese Laid-open Patent Publication No. 2012-143074
[Patent Document 2] Japanese Laid-open Patent Publication No. 2012-23957
[Patent Document 3] Japanese Laid-open Patent Publication No. 2011-229360
[Patent Document 4] Japanese National Publication of International Patent Application No. 2010-511316
[Patent Document 5] Japanese Laid-open Patent Publication No. 2013-27255
[Patent Document 6] Japanese Laid-open Patent Publication No. 2011-67590

### SUMMARY OF THE INVENTION

It is a general object of the present invention to provide a power transmitting apparatus and a power receiving apparatus that substantially obviates one or more problems caused by the limitations and disadvantages of the related art.

According to an embodiment, a wireless power receiving apparatus for wirelessly receiving power from a power transmitting apparatus includes a first power receiving coil, and a second power receiving coil having windings thereof parallel to, and in close proximity to, windings of the first power receiving coil.

A wireless power transmitting apparatus for wirelessly transmitting power to a power receiving apparatus includes a first power transmitting coil, and a second power transmitting coil having windings thereof parallel to, and in close proximity to, windings of the first power transmitting coil.

According to at least one embodiment, the efficiency of power transmission from a power transmitting apparatus to a power receiving apparatus is improved.

### BRIEF DESCRIPTION OF THE DRAWINGS

Other objects and further features of the present invention will be apparent from the following detailed description when read in conjunction with the accompanying drawings, in which:

FIG. 1 is a drawing illustrating a first relationship between coils used in a power transmitting apparatus and a power receiving apparatus;

FIG. 2 is a drawing illustrating a first power receiving coil and a second power receiving coil that are placed to overlap each other;

FIG. 3 is a drawing illustrating a second relationship between coils used in a power transmitting apparatus and a power receiving apparatus;

FIGS. 4A and 4B are drawings illustrating a first power receiving coil and a second power receiving coil that are arranged in bifilar winding;

FIG. 5 is a drawing illustrating a power receiving circuit employing a single loop coil;

FIG. 6 is a drawing illustrating a power receiving circuit according to a first embodiment;

FIG. 7 is a drawing illustrating a power receiving circuit according to a second embodiment;

FIG. 8 is a drawing illustrating a power receiving circuit according to a third embodiment;

FIG. 9 is a drawing illustrating the arrangement of loop coils in an apparatus for experiment for measuring the efficiency of a power transmission system;

FIG. 10 is a drawing illustrating a power receiving circuit according to a fourth embodiment;

FIG. 11 is a drawing illustrating the arrangement of loop coils in an apparatus for experiment for measuring the efficiency of a power transmission system;

FIG. 12 is a drawing illustrating a method of measuring transmission efficiency;

FIG. 13 is a drawing illustrating transmission loss in the first embodiment;

FIG. 14 is a drawing illustrating transmission loss in the second embodiment;

FIG. 15 is a drawing illustrating transmission loss in the third embodiment;

FIG. 16 is a drawing illustrating transmission loss in the fourth embodiment;

FIG. 17 is a drawing illustrating the transmission efficiency of loop coils employed in the first through third embodiments;

FIG. 18 is a drawing illustrating the transmission efficiency of loop coils employed in the fourth embodiment;

FIG. 19 is a drawing illustrating the transmission efficiency of loop coils in a logarithmic scale with respect to the first through fourth embodiments;

FIG. 20 is a drawing illustrating an appearance of a spiral coil;

FIG. 21 is a drawing illustrating two spiral coils that are placed in parallel to, and in close proximity to, each other;

FIG. 22 is a drawing illustrating a power receiving circuit employing a single spiral coil;

FIG. 23 is a drawing illustrating a power receiving circuit according to a fifth embodiment;

FIG. 24 is a drawing illustrating a power receiving circuit according to a sixth embodiment;

FIG. 25 is a drawing illustrating transmission loss measured with respect to the fifth embodiment with an inter-coil distance of 0.10 m;

FIG. 26 is a drawing illustrating transmission loss measured with respect to the fifth embodiment with an inter-coil distance of 0.20 m;

FIG. 27 is a drawing illustrating the transmission efficiency of spiral coils employed in the fifth and sixth embodiments; and

FIG. 28 is a drawing illustrating in a logarithmic scale the transmission efficiency of spiral coils employed in the fifth and sixth embodiments.

### DESCRIPTION OF THE PREFERRED EMBODIMENTS

In the following, embodiments of the present invention will be described with reference to the accompanying drawings.

### Loop-Coil-Based Embodiment

In the following, a description will be given of an embodiment in which loop coils (i.e., helical coils) are employed.

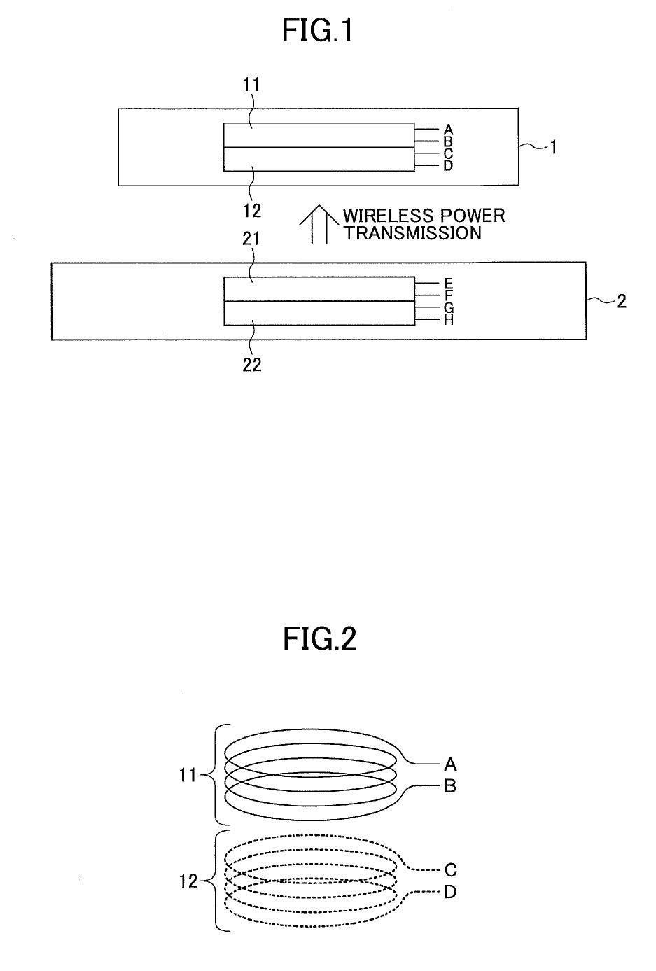

With reference to FIG. 1 and FIG. 2, a description will be given of a first relationship between the coils of a duplex loop coil structure, which is used in a power transmission apparatus and a power receiving apparatus of a power transmission system. FIG. 1 is a drawing illustrating the first relationship between coils used in a power transmitting apparatus and a power receiving apparatus. The first relationship refers to a relationship between the coils of a duplex loop coil structure that has a first coil and a second coil placed to overlap each other, as will be described below.

In FIG. 1, the power transmission system includes a power receiving apparatus 1 and a power transmitting apparatus 2 for wireless power transmission. The power receiving apparatus 1 includes a coil 11 serving as a first power receiving coil and a coil 12 serving as a second power receiving coil, which constitute a duplex loop coil structure. The power transmitting apparatus 2 includes a coil 21 serving as a first power transmitting coil and a coil 22 serving as a second power transmitting coil, which constitute a duplex loop coil structure. Through electromagnetic induction between the coils 11 and 12 of the power receiving apparatus 1 and the coils 21 and 22 of the power transmitting apparatus 2, the power receiving apparatus 1 receives electric power from the power transmitting apparatus 2.

The coil 11 is a loop coil comprised of wound wire having a wire end A and a wire end B. The coil 12 is a loop coil comprised of wound wire having a wire end C and a wire end D. The coil 11 and the coil 12 are placed to overlap each other such that the windings of the coil 11 are parallel to, and in close proximity to, the windings of the coil 12 (such that the axes of the coils are aligned with each other), thereby constituting a duplex loop coil structure. The wire ends A and B of the coil 11 and the wire ends C and D of the coil 12 are connected to a circuit (not shown) such that the coil 11 and the coil 12 have the same polarity. The overlapping placement of the coil 11 and the coil 12 enables close magnetic coupling between the coil 11 and the coil 12 that are parallel to each other in close proximity. Close magnetic coupling means a coupling coefficient k of 0.50 or greater between the first power receiving coil and the second power receiving coil. It may be noted that the coil 11 and the coil 12 are magnetically coupled with each other without using a core. The absence of a core ensures no iron loss.

In the present embodiment, the loop diameter of the coil 11 and the loop diameter of the coil 12 are made equal to each other (in terms of both the outer diameter and the inner diameter), thereby reducing the leak of magnetic flux to improve a coupling coefficient. However, the outer diameter or inner diameter may be set different between the coil 11 and the coil 12, which are placed to overlap each other.

Similarly to the coil 11 and the coil 12 of the power receiving apparatus 1, the coil 21 and the coil 22 in the power transmitting apparatus 2 are arranged such that the two bundles of wound wire are placed to overlap each other so as to be parallel to each other in close proximity. Accordingly, in the power transmitting apparatus 2 also, close magnetic coupling is established between the coil 21 and the coil 22. In the power transmitting apparatus 2, the wire ends E and F of the coil 21 and the wire ends G and H of the coil 22 are connected to a circuit (not shown) such that the coil 21 and the coil 22 have the same polarity.

In the following, a description will be given, by referring to FIG. 2, with respect to the details of the wound wire of the coil 11 and the coil 12 in the power receiving apparatus 1 illustrated in FIG. 1. FIG. 2 is a drawing illustrating the first power receiving coil and the second power receiving coil that face each other.

In FIG. 2, the wire end A is the start point of winding of the coil 11, and the wire end B is the end point of winding. The wire end C is the start point of winding of the coil 12, and the wire end D is the end point of winding. The turns of the coil 12 and the turns of the coil 11 are wound in the same direction. The coil 11 and the coil 12 are placed to overlap each other and to face each other, thereby forming a duplex loop coil structure.

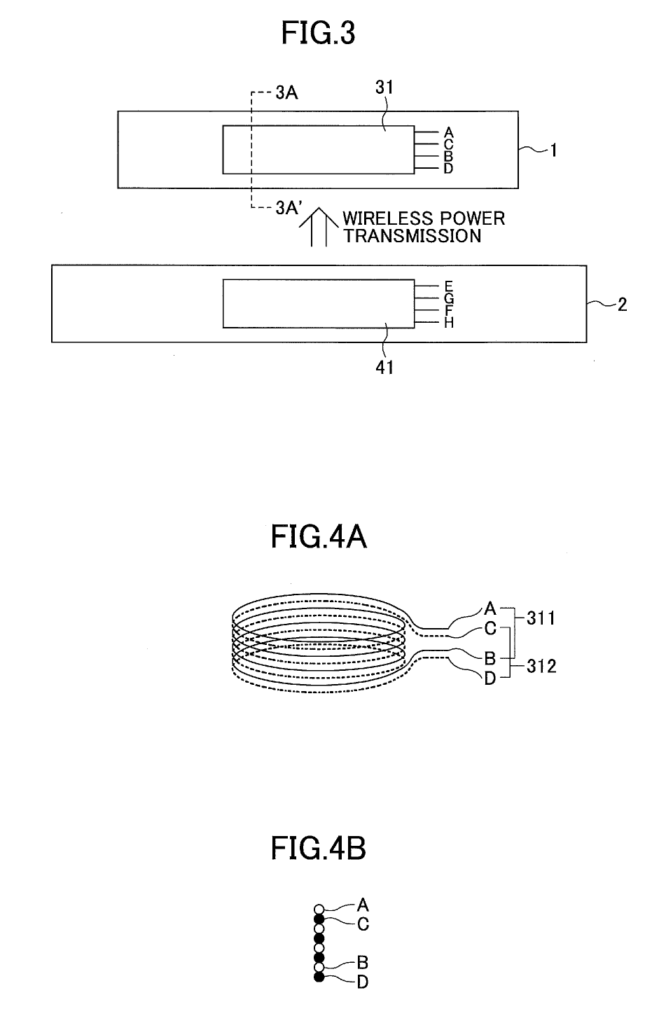

With reference to FIG. 3 and FIGS. 4A and 4B, a description will be given of a second relationship between the coils of a duplex loop coil structure, which is used in the power receiving apparatus 1 and the power transmitting apparatus 2. FIG. 3 is a drawing illustrating the second relationship between coils used in the power receiving apparatus 1 and the power transmitting apparatus 2. The second relationship refers to a relationship between the coils of a duplex loop coil structure that has a first coil and a second coil thereof arranged in bifilar winding, as will be described below.

In FIG. 3, the power receiving apparatus 1 includes a power receiving coil 31. The power transmitting apparatus 2 includes a power transmitting coil 41.

The power receiving coil 31 is a loop coil that has a first power receiving coil and a second power receiving coil arranged in bifilar winding. The first power receiving coil has a wire end A as the start point of winding and a wire end B as the end point of winding. The second power receiving coil has a wire end C as the start point of winding and a wire end D as the end point of winding. The detail of the power receiving coil 31 will be described with reference to FIGS. 4A and 4B. FIGS. 4A and 4B are drawings illustrating the first power receiving coil and the second power receiving coil that are arranged in bifilar winding. It may be noted that the power transmitting coil 41 of the power transmitting apparatus 2 also has a duplex loop coil structure that is constructed by use of bifilar winding in the same manner as in the power receiving coil 31. A description of the power transmitting coil 41 will be omitted.

In FIG. 4A, a wire 311 of the first power receiving coil and a wire 312 of the second power receiving coil are wound together side by side, starting from the wire end A and the wire end C, to form a duplex loop coil structure. FIG. 4B is a cross-sectional view taken along the line 3A-3A′ in FIG. 3. A loop-shaped coil has two rows of wires spaced apart from each other by the distance equal to the diameter of the loop. FIG. 4B illustrates only one of such two rows of wires. In FIG. 4B, the wire 311 of the first power receiving coil is illustrated by use of an open circle, and the wire 312 of the second power receiving coil is illustrated by use of a solid circle. FIG. 4B illustrates the wire 311 of the first power receiving coil and the wire 312 of the second power receiving coil wound together and alternately disposed.

The wire 311 of the first power receiving coil and the wire 312 of the second power receiving coil are wound together side by side, starting from the wire end A and the wire end B, respectively. As a result, the wire 311 of the first power receiving coil and the wire 312 of the second power receiving coil are alternately disposed in a vertical direction toward the wire end B and the wire end D as illustrated in FIG. 4B. FIG. 4B illustrates a simplified configuration in which only three turns are depicted for the sake of explanation. In reality, however, the power receiving coil 31 is formed by winding several tens of turns or several hundreds of turns in a similar manner.

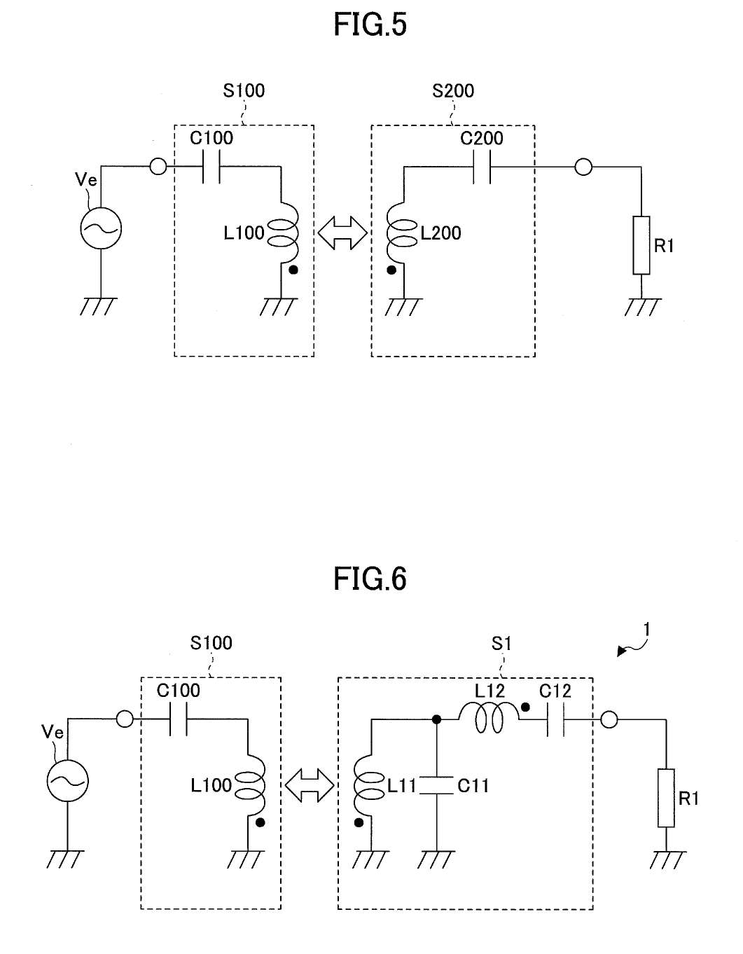

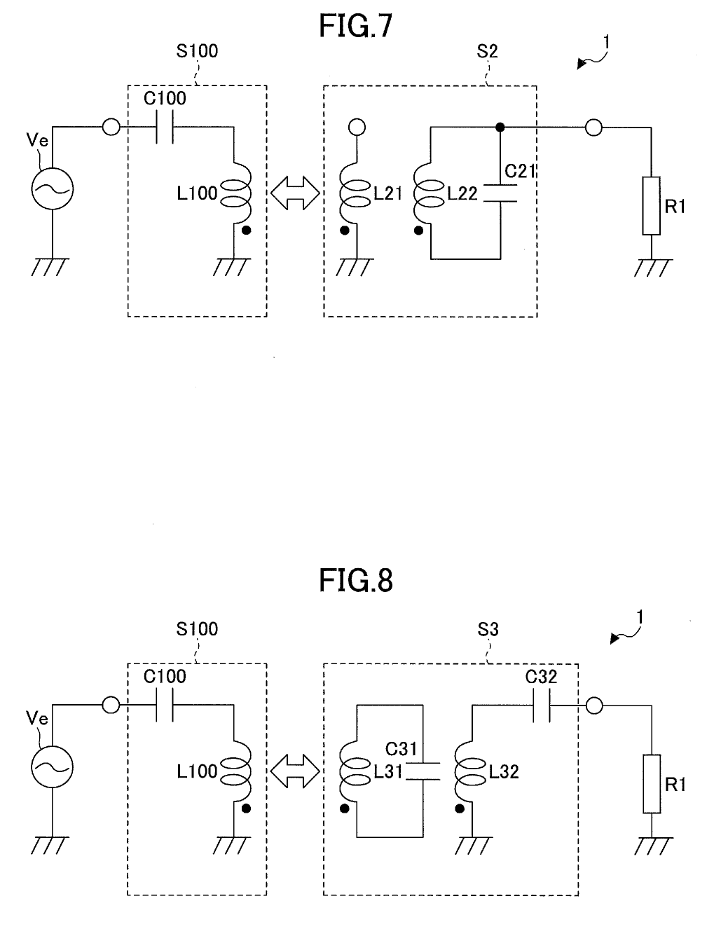

With reference to FIG. 5 through FIG. 8, a description will be given of the circuit configuration of a power transmission system according to first through third embodiments. FIG. 5 illustrates a configuration in which a single loop coil structure is employed in the power receiving apparatus for the purposes of comparison with the first through third embodiments. FIG. 6 is a drawing illustrating a power receiving circuit according to the first embodiment. FIG. 7 is a drawing illustrating a power receiving circuit according to the second embodiment. FIG. 8 is a drawing illustrating a power receiving circuit according to the third embodiment.

The first through third embodiments illustrated in FIG. 6 through FIG. 8 employ a duplex loop coil structure of bifilar winding illustrated in FIG. 3.

In FIG. 5, a power transmitting apparatus includes a power supply Ve and a circuit S100, which includes a capacitor C100, and an inductor L100. The capacitor C100 and the inductor L100 constitute a series resonance circuit. A power receiving apparatus includes a resistor R1 and a circuit S200, which includes an inductor L200 and a capacitor C200. The capacitor C200 and the inductor L200 constitute a series resonance circuit.

The power supply Ve is capable of changing the output frequency thereof by use of a tracking generator, which will be described later. The capacitor C100 and the capacitor C200 may have a capacitance of 47 pF.

The resistor R1, as illustrated in FIG. 5, has an upper end thereof connected to the capacitor C200 and a lower end thereof connected to the ground. The resistor R1 may have a resistance of 50Ω.

The polarity of the inductor L100 and the polarity of the inductor L200 are in the same direction as indicated by the solid circle marks.

The part of the power receiving apparatus in FIG. 5 that is enclosed in dotted lines corresponds to the circuit S200 of the power receiving apparatus. In the first through third embodiments illustrated in FIG. 6 through FIG. 8, a circuit S1 through a circuit S3 are employed, respectively, in place of the circuit S200.

In FIG. 6, the circuit S1 according to the first embodiment includes an inductor L11 serving as the first power receiving coil, a capacitor C11, an inductor L12 serving as the second power receiving coil, and a capacitor C12. In the circuit S1, the inductor L11 and the inductor L12, which have polarities in the illustrated directions, are wound together in bifilar winding to form a duplex loop coil structure. In the first embodiment, the inductor L11 and the inductor L12 have close magnetic coupling with each other with a coupling coefficient k of 0.61.

The inductor L11 and the capacitor C11 constitute a parallel resonance circuit. The inductor L12 and the capacitor C12 constitute a series resonance circuit. Each of the inductor L11 and the capacitor C11, as illustrated in FIG. 6, has a lower end thereof connected to the ground and an upper end thereof connected to a left end of the inductor L12. The capacitor C11 and the capacitor C12 may have a capacitance of 47 pF.

In FIG. 7, the circuit S2 according to the second embodiment includes an inductor L21 serving as the first power receiving coil, an inductor L22 serving as the second power receiving coil, and a capacitor C21. In the circuit S2, the inductor L21 and the inductor L22, which have polarities in the respective directions illustrated in FIG. 7, are wound together in bifilar winding to form a duplex loop coil structure. The inductor L21, as illustrated in FIG. 7, has a lower end thereof connected to the ground and an upper end thereof being open, thereby being placed in the no-load state. In the second embodiment, the inductor L21 and the inductor L22 have close magnetic coupling with each other with a coupling coefficient k of 0.61.

The inductor L22 and the capacitor C21 constitute a parallel resonance circuit. Each of the inductor L22 and the capacitor C21, as illustrated in FIG. 7, has a lower end thereof being open and an upper end thereof connected to the resistor R1. The capacitor C21 may have a capacitance of 47 pF.

In FIG. 8, the circuit S3 according to the third embodiment includes an inductor L31 serving as the first power receiving coil, a capacitor C31, an inductor L32 serving as the second power receiving coil, and a capacitor C32. In the circuit S3, the inductor L31 and the inductor L32, which have polarities in the respective directions illustrated in FIG. 8, are wound together in bifilar winding to form a duplex loop coil structure. In the third embodiment, the inductor L31 and the inductor L32 have close magnetic coupling with each other with a coupling coefficient k of 0.81.

The inductor L31 and the capacitor C31 constitute a parallel resonance circuit. Each of the inductor L31 and the capacitor C31, as is illustrated in FIG. 8, has a lower end thereof and an upper end thereof being both open. The inductor L32 and the capacitor C32 constitute a series resonance circuit. As illustrated in FIG. 8, the inductor L32 has a lower end thereof connected to the ground, and the capacitor C32 has a right end thereof connected to the resistor R1. The capacitor C31 and the capacitor C32 may have a capacitance of 47 pF.

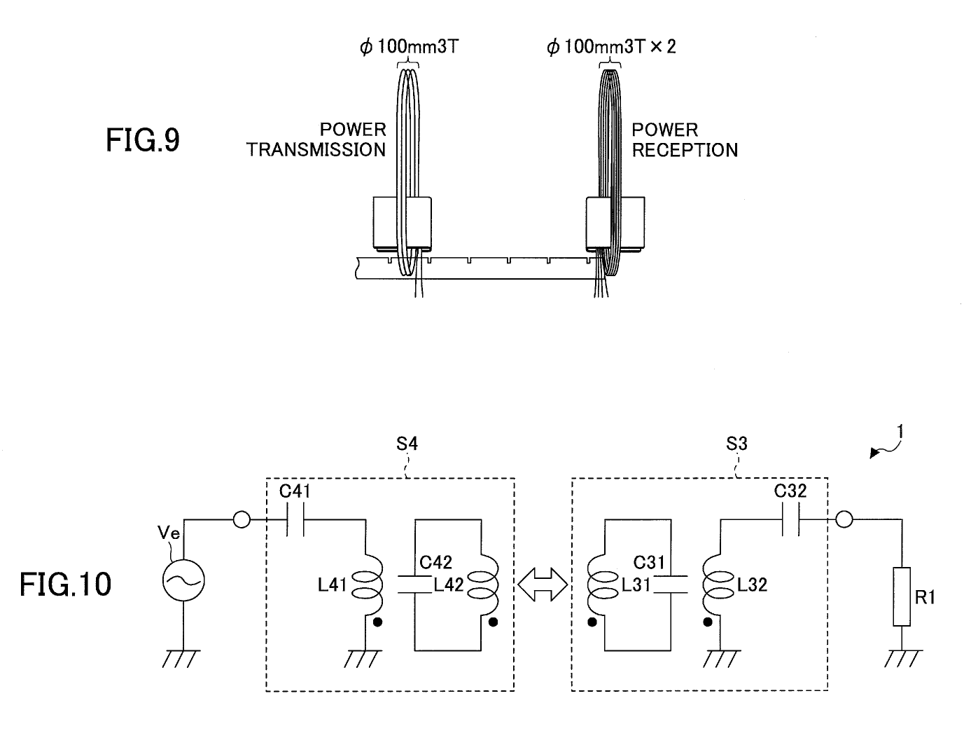

In the following, a description will be given of the arrangement of loop coils employed in an apparatus for experiment for the purpose of measuring a power transmission efficiency in the power receiving apparatus according to the first through third embodiments. FIG. 9 is a drawing illustrating an example of the arrangement of loop coils serving as power receiving coils used in the power receiving apparatus according to the first through third embodiments.

The apparatus for experiment illustrated in FIG. 9 was configured such that the inductor L100 of the power transmitting apparatus illustrated in FIG. 6 through FIG. 8 and the receiving-side coils (L11 and L12, L21 and L22, or L31 and L32) of the power receiving apparatus 1 were capable of being fixed to the apparatus in parallel to each other, with an adjustable distance between the transmitting-side coil and the receiving-side coils. The transmitting-side coil was made of UEW (i.e., polyurethane enabled copper wire) having a diameter of 1 mm, which was wound to form a three-turn loop with a diameter of 100 mm. The receiving-side coil was made of the same UEW as the transmitting-side coil, which was wound in bifilar winding to form a three-turn double loop with a diameter of 100 mm. The transmitting-side coil and the receiving-side coils were connected to the circuits that were described in connection with FIG. 6 through FIG. 8. The results of measuring the power transmission efficiency of the power receiving apparatus of the first through third embodiments obtained by using the apparatus for experiments illustrated in FIG. 9 will be described later.

In the following, a description will be given of the circuits of a power transmission system according to a fourth embodiment by referring to FIG. 10. In FIG. 10, the power receiving apparatus 1 employs the same circuit S3 that is employed in the third embodiment, and, also, the fourth embodiment employs the power transmitting apparatus 2 that includes a circuit S4 having the same circuit structure as the circuit S3.

In FIG. 10, the circuit S4 of the power transmitting apparatus 2 is configured to be left-right symmetric with the circuit S3 of the power receiving apparatus 1. The circuit S4 includes a capacitor C41, an inductor L41 serving as a first power transmitting coil, a capacitor C42, and an inductor L42 serving as a second power transmitting coil. In the circuit S4, the inductor L41 and the inductor L42, which have polarities in the respective directions illustrated in FIG. 10, are wound together in bifilar winding to form a duplex loop coil structure. In the fourth embodiment, the inductor L41 and the inductor L42 have close magnetic coupling with each other with a coupling coefficient k of 0.81.

The inductor L41 and the capacitor C41 constitute a series resonance circuit. The inductor L42 and the capacitor C42 constitute a parallel resonance circuit. As is illustrated in FIG. 10, the capacitor C41 has a left end thereof connected to the power supply Ve, and the inductor L41 has a lower end thereof connected to the ground. Each of the inductor L42 and the capacitor C42, as is illustrated in FIG. 10, has a lower end thereof and an upper end thereof being both open. The capacitor C41 and the capacitor C42 may have a capacitance of 47 pF.

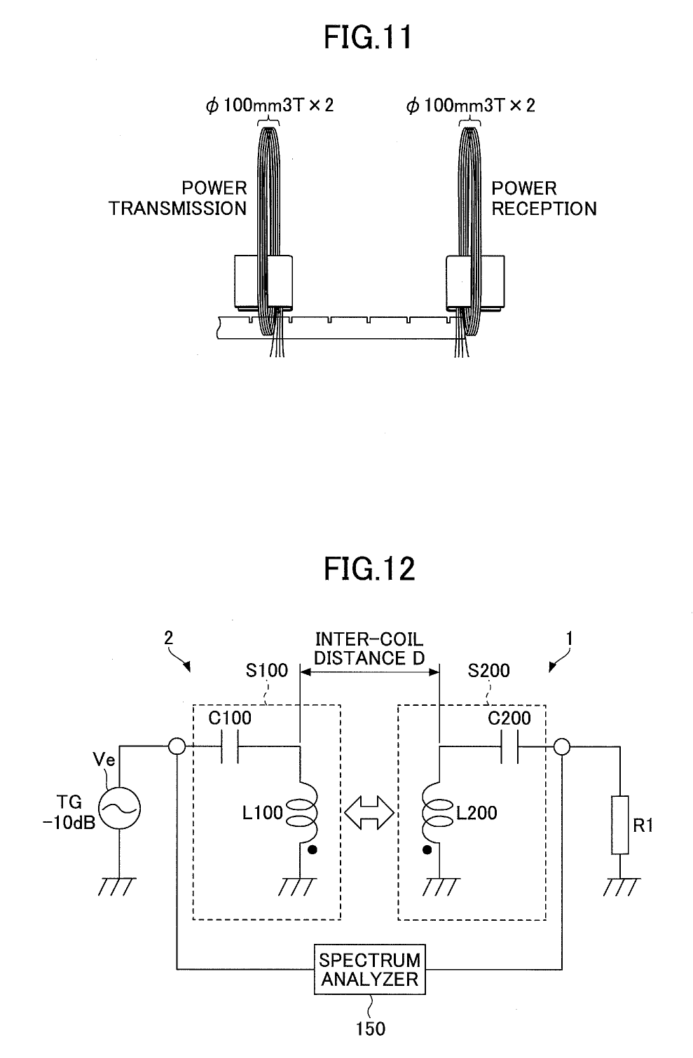

In the following, a description will be given of the arrangement of loop coils employed in an apparatus for experiment for the purpose of measuring a power transmission efficiency in the power receiving apparatus according to the fourth embodiment. FIG. 11 is a drawing illustrating the arrangement of loop coils employed in the fourth embodiment.

The apparatus for experiment illustrated in FIG. 11 was configured such that the transmitting-side coils (L41 and L42) of the power transmitting apparatus 2 illustrated in FIG. 10 and the receiving-side coils (L31 and L32) of the power receiving apparatus 1 were capable of being fixed to the apparatus in parallel to each other, with an adjustable distance between the transmitting-side coils and the receiving-side coils. In FIG. 11, the same bundles of wires as the receiving-side coils described in connection with FIG. 9 were used for both the transmitting-side coils and the receiving-side coils. The transmitting-side coils and the receiving-side coils were connected to the circuits that were described in connection with FIG. 10.

In the following, a description will be given of a method of measuring transmission efficiency in the first through fourth embodiments by referring to FIG. 12. FIG. 12 is a drawing illustrating a method of measuring transmission efficiency.

In FIG. 12, a spectrum analyzer 150 had the input impedance thereof equal to 50). The power supply Ve was a tracking generator, which generated a signal having frequency varying in synchronization with the sweeping of the spectrum analyzer 150. Transmission loss (dB) between the transmitting-side coils and the receiving-side coils was measured by changing the frequency of the output signal of the spectrum analyzer 150 within the range of 11 MHz to 16 MHz, with the reference level being set to −10 dB. Transmission efficiency η (%) is derived from transmission loss s (dB) by use of the following formula.

η=10^{(s/10)}×100 (1)

Transmission loss was measured with different distance settings with respect to a distance D between coils as was described in connection with FIG. 9 and FIG. 11, the different distance settings including 0.025 m, 0.05 m, 0.10 m, 0.15 m, 0.20 m, and 0.25 m.

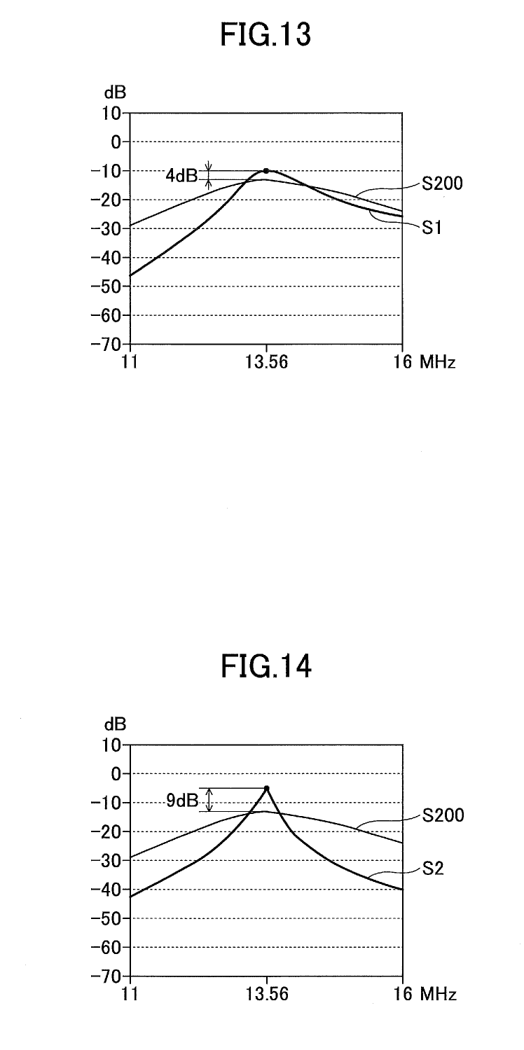

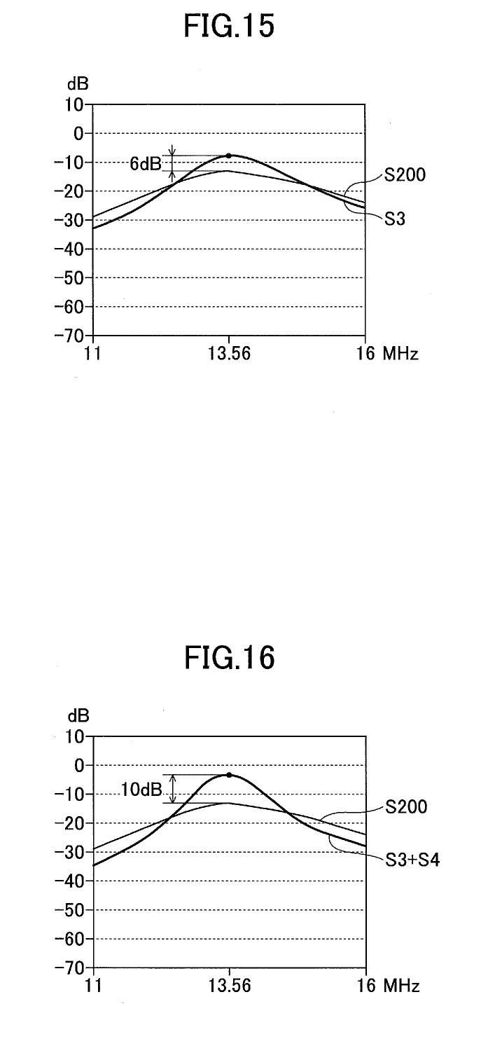

In the following, measured transmission loss will be described with reference to FIG. 13 through FIG. 16. FIG. 13 is a drawing illustrating transmission loss measured with respect to the first embodiment. FIG. 14 is a drawing illustrating transmission loss measured with respect to the second embodiment. FIG. 15 is a drawing illustrating transmission loss measured with respect to the third embodiment. FIG. 16 is a drawing illustrating transmission loss measured with respect to the fourth embodiment.

FIG. 13 illustrates the transmission loss of the first embodiment measured with an inter-coil distance of 0.1 m. The vertical axis represents transmission loss (dB), and the horizontal axis represents frequency (MHz). FIG. 13 also illustrates transmission loss as occurred by use of the circuit S200 in the single loop coil configuration illustrated in FIG. 5 for the purpose of comparison with the transmission loss of the circuit S1 of the first embodiment for the same frequency range. The results of measurement taken with respect to the circuit S1 are indicated by a label “S1”, and the results of measurement taken with respect to the circuit S200 are indicated by a label “S200”. In FIG. 14 through FIG. 16 also, the transmission loss of the circuit S200 is illustrated for comparison purposes.

With the use of the circuit S1 of the first embodiment, as illustrated in FIG. 13, a transmission loss of −10.0 dB was detected at 13.56 MHz with an inter-coil distance of 0.1 m. Transmission efficiency can be obtained by substituting the measured value of transmission loss into the formula (1). When transmission loss is −10.0 dB, an efficiency η of 10% is obtained.

The results of measuring transmission loss indicate that the transmission loss of the circuit S1 is lower than the transmission loss of the circuit S200 around 13.56 MHz, which is the resonant frequency. The transmission loss characteristics of the circuit S200 have a gentle curve within the measured frequency range. The transmission loss of the circuit S1, on the other hand, exhibits a sharper peak than the transmission loss of the circuit S200 around the resonant frequency. At the position of the peak, the transmission loss of the circuit S1 is approximately 4-dB lower than the transmission loss of the circuit S200.

The transmission loss of the circuit S1 according to the first embodiment was measured with respect to different distances, which were set to 0.25 m, 0.05 m, 0.10 m, 0.15 m, 0.20 m, and 0.25 m, respectively.

It may be noted that 13.56 MHz corresponds to an ISM (i.e., industrial, scientific and medical) band assigned by the International Telecommunication Union. In the embodiments disclosed herein, the time constants of the resonant circuit were set in accordance with the use of 13.56 MHz. All measurements described herein were taken in a radio-dark room.

FIG. 14 illustrates the transmission loss of the second embodiment measured with an inter-coil distance of 0.1 m. With the use of the circuit S2 of the second embodiment, as illustrated in FIG. 14 with the label “S2”, a transmission loss of −4.0 dB was detected at 13.56 MHz with an inter-coil distance of 0.1 m. When transmission loss is −4.0 dB, an efficiency η of approximately 40% is obtained from the formula (1). The transmission loss of the circuit S2 exhibits a reduction of approximately 9 dB, compared with the transmission loss of the circuit S200.

FIG. 15 illustrates the transmission loss of the third embodiment measured with an inter-coil distance of 0.1 m. With the use of the circuit S3 of the third embodiment, as illustrated in FIG. 15 with the label “S3”, a transmission loss of −7.0 dB was detected at 13.56 MHz with an inter-coil distance of 0.1 m. When transmission loss is −7.0 dB, an efficiency η of approximately 20% is obtained from the formula (1). The transmission loss of the circuit S3 exhibits a reduction of approximately 6 dB, compared with the transmission loss of the circuit S200.

FIG. 16 illustrates the transmission loss of the fourth embodiment measured with an inter-coil distance of 0.1 m. With the use of the circuit S4 of the fourth embodiment, as illustrated in FIG. 16 with the label “S4”, a transmission loss of −3.7 dB was detected at 13.56 MHz with an inter-coil distance of 0.1 m. When transmission loss is −3.7 dB, an efficiency η of approximately 42% is obtained from the formula (1). The transmission loss of the circuit S4 exhibits a reduction of approximately 10 dB, compared with the transmission loss of the circuit S200.

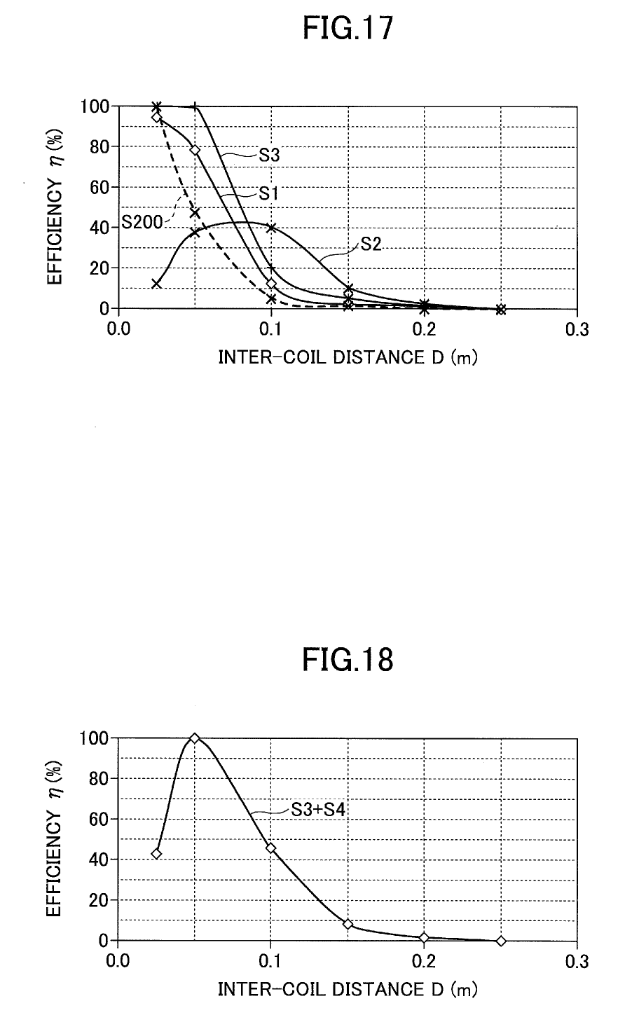

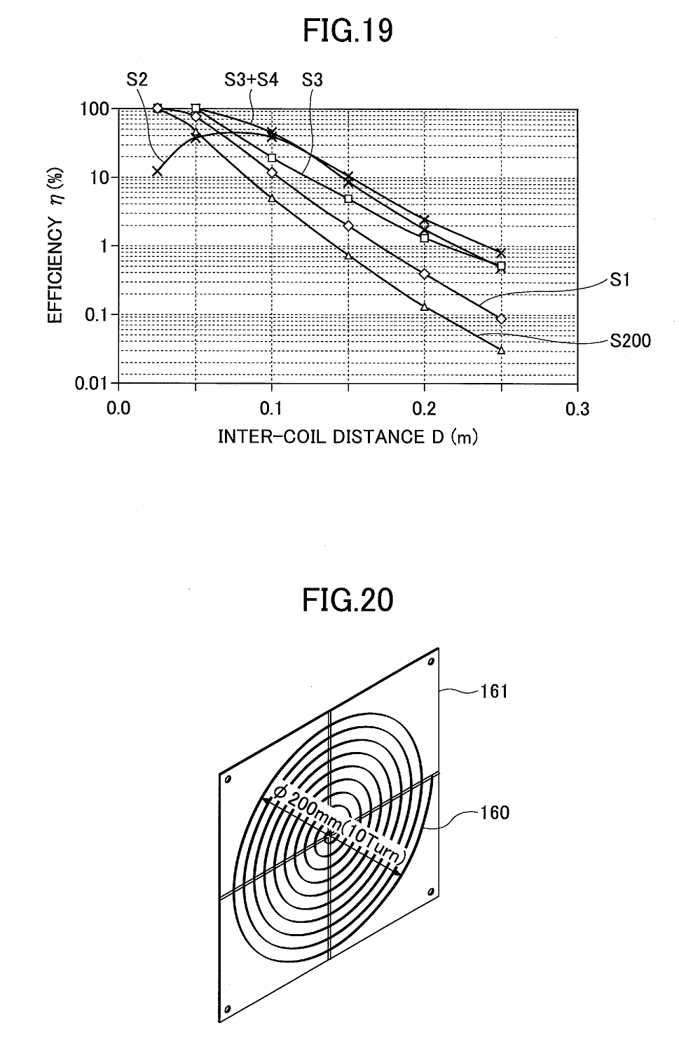

In the following, with reference to FIG. 17, a description will be given of transmission efficiency as observed for different inter-coil distances with respect to the first through third embodiments. Further, with reference to FIG. 18, a description will be given of transmission efficiency as observed for different inter-coil distances with respect to the fourth embodiment. Moreover, with reference to FIG. 19, a description will be given of transmission efficiency as observed when the vertical axes of FIG. 17 and FIG. 18 are changed to a logarithmic-scale axis.

FIG. 17 is a drawing illustrating the transmission efficiency of loop coils employed in the first through third embodiments. FIG. 18 is a drawing illustrating the transmission efficiency of loop coils employed in the fourth embodiment. FIG. 19 is a drawing illustrating the transmission efficiency of loop coils in a logarithmic scale with respect to the first through fourth embodiments.

FIG. 17 and FIG. 18 illustrate the transmission efficiency η derived by use of the formula (1) based on transmission losses that were measured in the same manner as in the measurements taken and illustrated in FIG. 13 through FIG. 16 but measured with respect to the different inter-coil distances previously described. The horizontal axis in FIG. 17 and FIG. 18 represents an inter-coil distance (m), and the vertical axis represents the transmission efficiency η (%). Frequency used for measurement was 13.56 MHz.

In FIG. 17, a dashed line indicated by the label “S200” illustrates the transmission efficiency obtained by use of the circuit S200 for comparison purposes. The transmission efficiency of the circuit S1 of the first embodiment (indicated by the label “S1”) and the transmission efficiency of the circuit S3 of the third embodiment (indicated by the label “S3”) are higher than the transmission efficiency of the circuit S200 across the entire range of inter-coil distances. Further, the circuit S3 exhibits higher transmission efficiency than the circuit S1. Both the circuit S1 and the circuit S3 exhibit transmission efficiency that increases as the inter-coil distance decreases in the range below 0.25 m, and that shows a sudden rise as the inter-coil distance falls below 0.12 m. The transmission efficiency curves of the circuit S1 and the circuit S3 have a point of inflection around an inter-coil distance of 0.07 to 0.08 m, and the slope of the curve decreases as the inter-coil distance decreases further from the inflection point.

The transmission efficiency of the circuit S2 of the second embodiment (indicated by the label “S2”) exhibits significant improvement over the transmission efficiencies of the circuit S1 and the circuit S3 when the inter-coil distance is within a certain range below 0.25 m. The transmission efficiency curve of the circuit S2 has a point of inflection around an inter-coil distance of 0.12 m, and assumes a maximum value around 0.08 m. The circuit S2 exhibits higher transmission efficiency than the circuit S1 and the circuit S3 in the range above around 0.07 m or 0.08 m in the inter-coil distance.

In FIG. 18, the transmission efficiency of the combination of the circuit S3 at the receiving side and the circuit S4 at the transmitting side in the fourth embodiment (indicated by the label “S3+S4”) assumes a maximum value at an inter-coil distance of approximately 0.05 m, and decreases as the inter-coil distance decreases in the range below 0.05 m.

FIG. 19 illustrates changes in the transmission efficiencies of the first through fourth embodiments as a function of the inter-coil distance. The results illustrated in FIG. 19 indicate that the inter-coil distance achieving the highest transmission efficiency varies from embodiment to embodiment. In the range above an inter-coil distance of approximately 0.12 m, the second embodiment has the highest transmission efficiency than the remaining embodiments. In the range of 0.05 m to 0.12 m in the inter-coil distance, the fourth embodiment has the highest transmission efficiency. In the range below an inter-coil distance of 0.05 m, the third embodiment has the highest transmission efficiency. It may be noted that a difference between the transmission efficiency of the third embodiment and the transmission efficiency of the circuit S200 employing a single loop coil is small in the range below 0.25 m in the inter-coil distance. The observations made above indicate that the most preferable embodiment may vary depending on the distance between the coils of the power receiving apparatus 1 and the coils of the power transmitting apparatus 2.

### Spiral-Coil-Based Embodiment

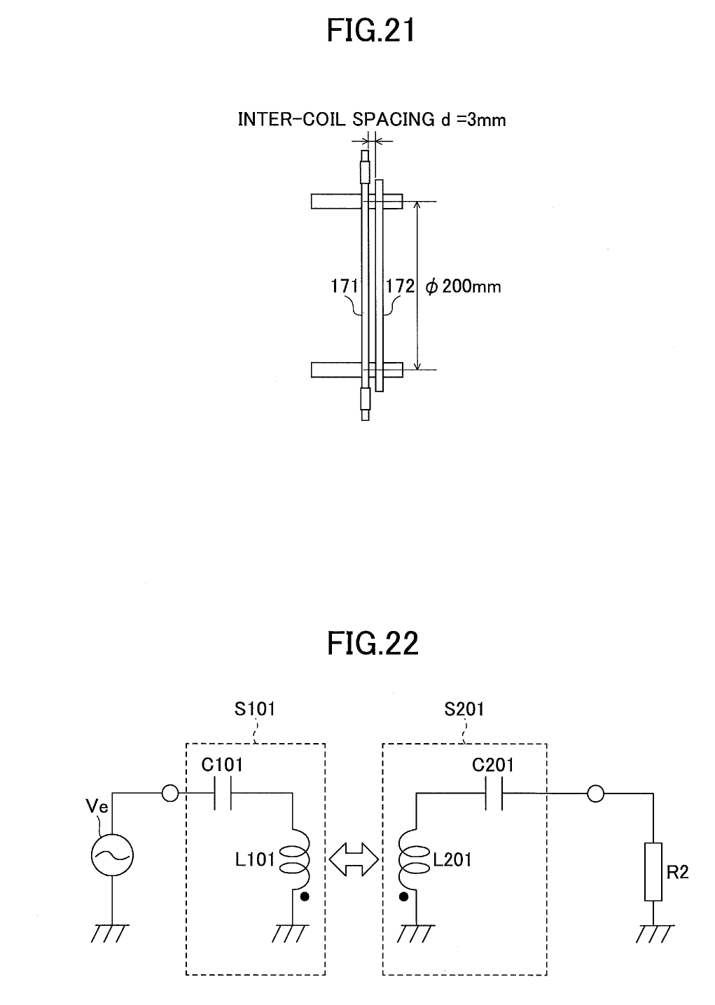

In the following, a description will be given of an embodiment in which spiral coils are employed. The shape of a spiral coil will be described with reference to FIG. 20 and FIG. 21. FIG. 20 is a drawing illustrating an appearance of a spiral coil. FIG. 21 is a drawing illustrating two spiral coils placed in parallel to each other in close proximity.

In FIG. 20, a spiral coil 160 is made of UEW having a diameter of 1 mm, which is wound with 10-mm turn spacing to form a 10-turn spiral loop having an outer diameter of 200 mm. In the present embodiment, the spiral coil of the power transmitting apparatus 2 is a single spiral coil formed of a single wire. The spiral coil of the power transmitting apparatus 2 is fixedly mounted on a transmitting-side resin plate 161.

The spiral coil of the power receiving apparatus 1 has a duplex spiral coil structure in which two wires made of the same UEW as the spiral coil of the power transmitting apparatus 2 are placed in parallel to, and in close proximity to, each other. The two wires are placed in close magnetic coupling with each other with a coupling coefficient k of 0.77. As illustrated in FIG. 21, the spiral coils of the power receiving apparatus 1 are fixedly mounted on receiving-side resin plates 171 and 172 similarly to the spiral coil of the power transmitting apparatus 2. The arrangement of the receiving-side resin plates 171 and 172 in close proximity to each other achieves close magnetic coupling between the coils mounted thereon.

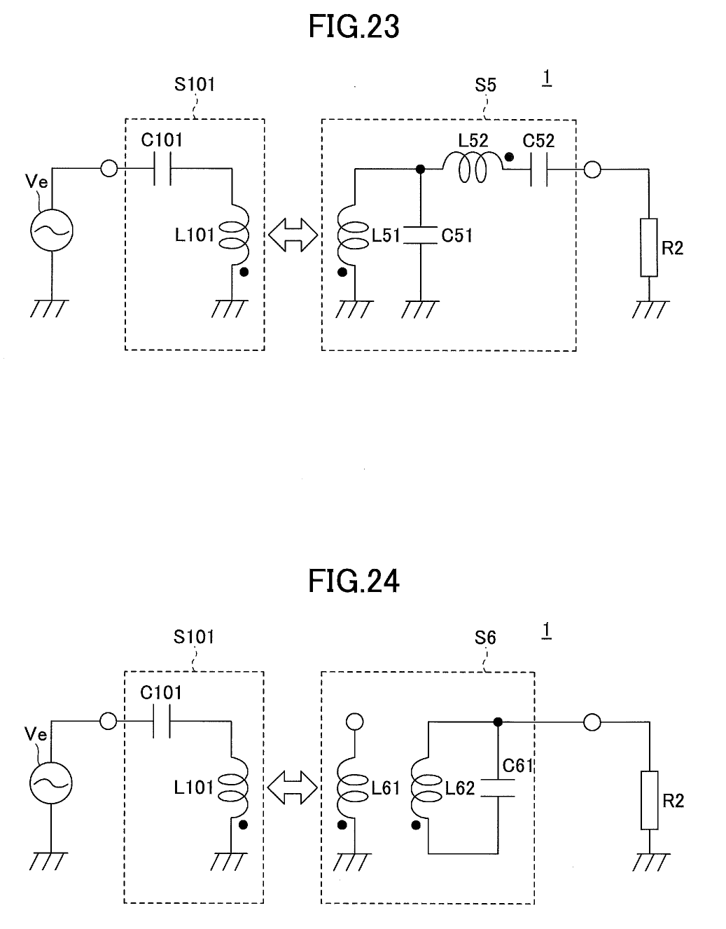

With reference to FIG. 22 through FIG. 24, a description will be given of the circuit configuration of a power transmission system according to fifth and sixth embodiments. FIG. 22 illustrates a configuration in which a single spiral coil structure is employed in both the power transmitting apparatus and the power receiving apparatus for the purposes of comparison with the fifth and sixth embodiments. In the fifth embodiment and the sixth embodiment, a duplex spiral coil structure is utilized in the power receiving apparatus 1. FIG. 23 is a drawing illustrating a power receiving circuit according to the fifth embodiment. FIG. 24 is a drawing illustrating a power receiving circuit according to the sixth embodiment.

The fifth and sixth embodiments illustrated in FIG. 23 and FIG. 24 employ the duplex spiral coil structure described in connection with FIG. 20 and FIG. 21.

In FIG. 22, a power transmitting apparatus includes a power supply Ve and a circuit S101, which includes a capacitor C101, and an inductor L101. The capacitor C101 and the inductor L101 constitute a series resonance circuit. A power receiving apparatus includes a resistor R2 and a circuit S201, which includes an inductor L201 and a capacitor C201. The capacitor C201 and the inductor L201 constitute a series resonance circuit.

The power supply Ve is capable of changing the output frequency thereof by use of a tracking generator. The capacitor C101 and the capacitor C201 may have a capacitance of 320 pF.

The resistor R2, as is illustrated in FIG. 22, has an upper end thereof connected to the capacitor C201 and a lower end thereof connected to the ground. The resistor R2 may have a resistance of 50Ω.

The part of the power receiving apparatus in FIG. 22 that is enclosed in dotted lines corresponds to the circuit S201 of the power receiving apparatus. In the fifth and sixth embodiments illustrated in FIG. 23 and FIG. 24, a circuit S5 and a circuit S6 are employed, respectively, in place of the circuit S201.

In FIG. 23, the circuit S5 of the fifth embodiment differs from the circuit S1 of the first embodiment illustrated in FIG. 6 in that a duplex spiral coil structure is employed. The circuit S5 includes an inductor L51 serving as a first power receiving coil, a capacitor C51, an inductor L52 serving as a second power receiving coil, and a capacitor C52. In the circuit S5, the inductor L51 and the inductor L52, which have polarities in the respective directions illustrated in FIG. 23, are placed in close proximity to each other to form a duplex spiral coil structure. In the fifth embodiment, the inductor L51 and the inductor L52 have close magnetic coupling with each other with a coupling coefficient k of 0.77.

The inductor L51 and the capacitor C51 constitute a parallel resonance circuit. The inductor L52 and the capacitor C52 constitute a series resonance circuit. Each of the inductor L51 and the capacitor C51, as is illustrated in FIG. 23, has a lower end thereof connected to the ground and an upper end thereof connected to a left end of the inductor L52. The capacitor C51 and the capacitor C52 may have a capacitance of 320 pF.

In FIG. 24, the circuit S6 of the sixth embodiment has the same configuration as the circuit S2 of the second embodiment illustrated in FIG. 7 as far as the circuit diagrams are concerned. The circuit S6 includes an inductor L61 serving as a first power receiving coil, an inductor L62 serving as a second power receiving coil, and a capacitor C61. In the circuit S6, the inductor L61 and the inductor L62, which have polarities in the respective directions illustrated in FIG. 24, are placed in close proximity to each other to form a duplex spiral coil structure. The inductor L61, as is illustrated in FIG. 24, has a lower end thereof connected to the ground and an upper end thereof being open, thereby being placed in the no-load state. In the sixth embodiment, the inductor L61 and the inductor L62 have close magnetic coupling with each other with a coupling coefficient k of 0.77.

The inductor L62 and the capacitor C61 constitute a parallel resonance circuit. Each of the inductor L62 and the capacitor C61, as illustrated in FIG. 24, has a lower end thereof being open and an upper end thereof connected to the resistor R2. The capacitor C61 may have a capacitance of 320 pF.

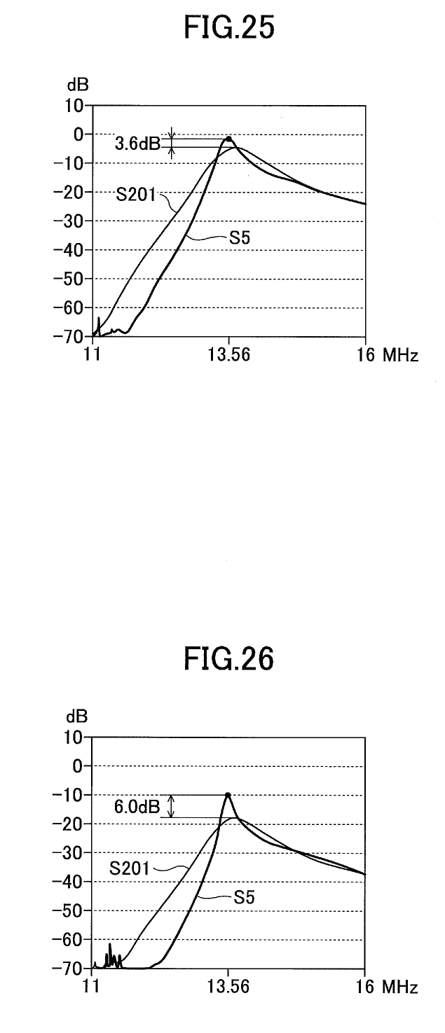

In the following, measured transmission loss will be described with reference to FIG. 25 and FIG. 26. FIG. 25 is a drawing illustrating transmission loss measured with respect to the fifth embodiment with an inter-coil distance of 0.10 m. FIG. 26 is a drawing illustrating transmission loss measured with respect to the fifth embodiment with an inter-coil distance of 0.20 m. The apparatus for measuring transmission loss had a similar configuration to that of the apparatus for experiment illustrated in FIG. 12.

With the use of the circuit S5 of the fifth embodiment, as illustrated in FIG. 25, a transmission loss of −0.9 dB was detected at 13.56 MHz with an inter-coil distance of 0.10 m. When transmission loss is −0.9 dB, an efficiency η of approximately 81% is obtained from the formula (1). The transmission loss of the circuit S5 exhibits a reduction of approximately 3.6 dB, compared with the transmission loss of the circuit S201.

In the example illustrated in FIG. 26, a transmission loss of −10 dB was detected at 13.56 MHz with an inter-coil distance of 0.20 m. When transmission loss is −10 dB, an efficiency η of approximately 10% is obtained from the formula (1). The transmission loss of the circuit S5 exhibits a reduction of approximately 6.0 dB, compared with the transmission loss of the circuit S201.

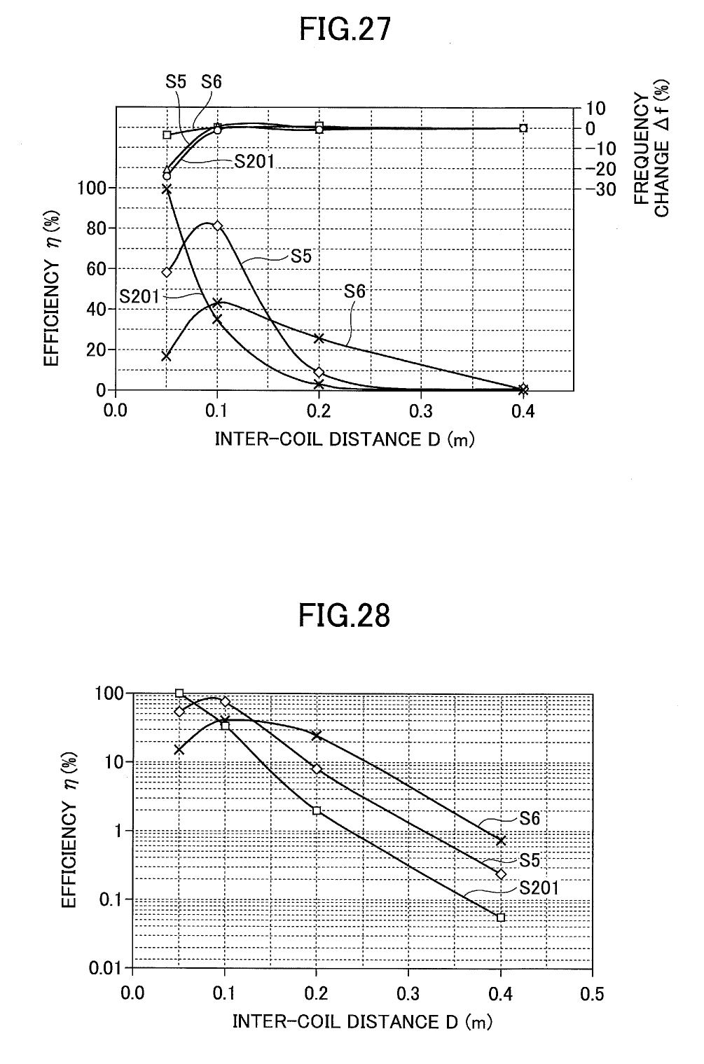

In the following, with reference to FIG. 27 and FIG. 28, a description will be given of transmission efficiency as observed for different inter-coil distances with respect to the fifth and sixth embodiments.

FIG. 27 is a drawing illustrating the transmission efficiency of spiral coils and changes in resonance frequency with respect to the fifth embodiment and the sixth embodiment.

FIG. 27 illustrates transmission efficiency derived by use of the formula (1) based on transmission losses measured by setting the inter-coil distance to 0.05 m, 0.10 m, 0.20 m and 0.40 m, respectively, with respect to the fifth embodiment and the sixth embodiment. The horizontal axis in FIG. 27 represents an inter-coil distance (m), and the left vertical axis represents the transmission efficiency η (%). The right vertical axis in FIG. 27 represents a change Δf (%) in resonance frequency. Characteristic curves illustrated in an upper part of FIG. 27 show changes in resonance frequency, and characteristic curves illustrated in a lower part of FIG. 27 show transmission efficiencies. Changes in resonance frequency are obtained by measuring a change in resonance frequency resulting from a decrease in the inter-coil distance D. In so doing, the reference level (i.e., corresponding to a frequency change of 0%) is set for an infinite inter-coil distance, i.e., set for the condition in which the mutual inductance between the power transmitting coil and the power receiving coil is zero.

In FIG. 27, a characteristic curve indicated by the label “S201” illustrates the transmission efficiency of the circuit S201 provided for comparison purposes. The transmission efficiency of the fifth embodiment indicated by the label “S5” exhibits a peak having an efficiency of approximately 82% when the inter-coil distance is approximately 0.09 m, and decreases as the inter-coil distance falls below 0.09 m. The transmission efficiency of the sixth embodiment indicated by the label “S6” exhibits a peak having an efficiency of approximately 42% when the inter-coil distance is approximately 0.10 m, and decreases as the inter-coil distance falls below 0.10 m.

Comparison of the transmission efficiencies of the circuit S5 and the circuit S6 reveals that the transmission efficiency of the circuit S6 is higher than the transmission efficiencies of the circuit S201 and the circuit S5 in the range above 0.16 m in the inter-coil distance. The transmission efficiency of the circuit S5 is higher than the transmission efficiencies of the circuit S201 and the circuit S6 in the range of approximately 0.07 m to 0.16 m in the inter-coil distance. The transmission efficiency of the circuit S201 is higher than the transmission efficiencies of the circuit S5 and the circuit S6 in the range below approximately 0.07 m in the inter-coil distance.

The change Δf in resonant frequency increases as the inter-coil distance decreases in the range below approximately 0.1 m. A change in resonant frequency is greater in the circuit S5 and the circuit S201 than in the circuit S6.

FIG. 28 is a drawing illustrating in logarithmic scale the transmission efficiencies of spiral coils employed in the fifth embodiment and the sixth embodiment illustrated in FIG. 27.

In FIG. 28, transmission efficiency is the highest in the circuit S6, the next highest in the circuit S5, and the lowest in the circuit S201 in the range above 0.2 m in the inter-coil distance.

A description has heretofore been given of a duplex power receiving coil structure employed in the power receiving apparatus 1 with respect to the first through sixth embodiment. In the fourth embodiment, a duplex coil structure is also employed for the power transmitting coils in the power transmitting apparatus 2. The duplex coil structures employed in these embodiments are applicable to power transmitting coils in the power transmitting apparatus 2.

Further, the present invention is not limited to these embodiments, but various variations and modifications may be made without departing from the scope of the present invention.

The present application is based on and claims the benefit of priority of Japanese priority application No. 2013-272954 filed on Dec. 27, 2013, with the Japanese Patent Office, the entire contents of which are hereby incorporated by reference.

What is claimed is:

1. A wireless power receiving apparatus for wirelessly receiving power from a power transmitting apparatus, comprising:
a first power receiving coil; and
a second power receiving coil having windings thereof parallel to, and in close proximity to, windings of the first power receiving coil.

2. The wireless power receiving apparatus as claimed in claim 1, wherein the windings of the first power receiving coil and the windings of the second power receiving coil are arranged in bifilar winding.

3. The wireless power receiving apparatus as claimed in claim 1, wherein the first power receiving coil and the second power receiving coil are placed to overlap each other.

4. The wireless power receiving apparatus as claimed in claim 1, wherein the first power receiving coil and the second power receiving coil are in close magnetic coupling with each other.

5. The wireless power receiving apparatus as claimed in claim 1, further comprising:
a first capacitor configured to form a parallel resonance circuit with the first power receiving coil; and
a second capacitor configured to form a series resonance circuit with the second power receiving coil.

6. The wireless power receiving apparatus as claimed in claim 1, wherein the first power receiving coil is in a no-load state.

7. A wireless power transmitting apparatus for wirelessly transmitting power to a power receiving apparatus, comprising:
a first power transmitting coil; and
a second power transmitting coil having windings thereof parallel to, and in close proximity to, windings of the first power transmitting coil.
